(19) United States
(12) Patent Application Publication
(10) Pub. No.: US 2008/0005007 A1
(43) Pub. Date: Jan. 3, 2008

(54) Investment Portfolio and Method of Selecting Investment Components of an Investment Portfolio

(75) Inventors: Zhiwu Chen, Woodbridge, CT (US); Roger Ibbotson, Hamden, CT (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: ZEBRA FUND ADVISORS, LLC, Milford, CT (US)

(21) Appl. No.: 11/854,154

(22) Filed: Sep. 12, 2007

(51) Int. Cl. G06Q 40/00

(52) U.S. Cl. 705/36 R

(57) ABSTRACT

An investment portfolio and a method of selecting investment portfolio components, contrary to the risks suggested by the literature in doing so, overweight less liquid investments, and underweight more liquid ones, relative to some liquidity-neutral benchmark portfolio weights for some or all of the components of the portfolio.

### TECHNICAL FIELD

This patent relates to investment portfolios that may include one or more investment components and methods of selecting components for an investment portfolio.

### BACKGROUND

Investment practitioners and academics have focused in developing investment portfolios on one, or a combination of, generally three investment styles/approaches: size, value/growth, and momentum. That is, since small-cap stocks are known to do better in the long-run than their large-cap counterparts, one can favor small-cap stocks; since value tends to outperform growth, an investor can bias against growth (Fama and French 1993, 1996); as past winners and losers are likely to repeat their fortunes in the future, an investor may load up on past winners and bias against past losers (Jegadeesh and Titman 1993, 2001).

The literature describe that less liquid (i.e., less traded) stocks outperform popular and more heavily traded glamorous stocks. Amihud and Medleson in two articles in 1986 study the bid-ask as a measure for liquidity and its impact stock on returns. Conrad, Hameed and Niden (1994) use weekly data to show that past trading volume can explain some of the short-term price reversal patterns in stock price movements. Datar, Naik and Radcliffe (1998) demonstrate that low-volume stocks on average earn higher future returns than high-volume stocks, where turnover is used as a measure of a stock's trading volume that is comparable across stocks. Like a later study by Pastor and Stambaugh (2003), Datar et al (1998) attribute the higher returns by low-volume stocks to a liquidity risk premium. That is, according to the liquidity hypothesis, stocks that have low turnover are less liquid and hence present a liquidity risk for which the investors should be compensated, resulting in lower valuation for a low-volume stock. However, in another study, Lee and Swaminathan (1998) show that the liquidity hypothesis is not totally consistent with their evidence. They study the joint interaction between past stock price momentum and trading volume. In particular, they find that the return spread between past winners and past losers (i.e., the momentum premium) is much higher among high-volume stocks: between 1965 and 1995, a strategy of buying high-volume winners and selling short high-volume losers can outperform a similar momentum strategy using price returns alone by 1.8% to 2.7% per year. Lee and Swaminathan (1998) propose an Expectations Life Cycle Hypothesis, that is, trading volume serves as an indicator of investor interest in the stock: when a stock falls into disfavor, the number of sellers dominates buyers, leading to low trading volume, whereas when a stock becomes popular or glamorous, buyers dominate sellers, resulting in higher prices and higher volume. Thus, a relatively low turnover is indicative of a stock near the bottom of its expectation cycle, while a relatively high volume indicative of a firm close to the top of its expectation cycle. They find that among past losers, low volume is a particularly useful signal suggesting that the stock has “bottomed out”, with upward price movement being the more likely to occur going forward. Based on their reasoning, high-volume losers still have plenty of negative price momentum and hence more downside to continue.

Not withstanding the Lee-Sawminathan (1998) Expectations Life Cycle Hypothesis, theory and empirical work on financial development have made it abundantly clear that one fundamental role played by financial markets is to make otherwise illiquid assets liquid. That is, through the financialization of physical assets and otherwise non-tradable future cashflows, securities markets make such value and wealth more liquid, which in turn makes capital more productive and easier to allocate across competing projects. This process of financialization therefore creates more value out of the same amount of wealth or value. Since liquidity creation is at the center of financial development and since value creation comes with increased liquidity, liquid stocks should be priced higher than illiquid ones. In a relatively small set of literature, illiquidity discounts in security valuation have been documented. For example, Silber (1991) shows that in the U.S. Rule 144 stocks with a two-year no-trading restriction have an average price discount of 35% relative to the freely traded, otherwise identical, common shares of the same company. On the U.S. bond market, Amihud and Mendelson (1991) and Kamara (1994) document that the average yield spread between illiquid Treasury notes and liquid Treasury bills of the same maturity is more than 35 basis points. According to Boudoukh and Whitelaw (1991), the yield spread is more than 50 basis points between the designated benchmark government bond and similar but less liquid government bonds in Japan. For stocks in China, Chen and Xiong (2001) find that the average discount for restricted legal-person shares relative to their otherwise identical freely-tradable shares issued by the same company is 86%, where the legal-person shares are only held by legal-person corporations but only transferable through private transactions and cannot be traded on any open market. The evidence is thus quite clear that securities of less liquidity are priced lower, regardless of country and business culture. Thus, investors are paid to hold illiquid securities. The recent growth trend in private equity and venture capital funds is also indicative of the extra returns that come with less liquid investment instruments.

While the existing literature has found strong evidence for the illiquidity effect in stock returns, no methods have been proposed to form investment strategies by directly incorporating illiquidity into portfolio weights. Prior attempts to include a turnover or volume factor in a multifactor return forecasting model and then form portfolios based on such return forecasts have not been satisfactory as they may subject the portfolio to model estimation risk and the possibility that the future may not turn out to be like the past. Structuring a portfolio simply around a collection of low-volume stocks may put a limit on the maximum capacity that can be accommodated as it favors small-cap stocks.

As is clear from the foregoing discussion, portfolio structure and the strategies utilized to structure portfolios is an uncertain science. The expectation of satisfactory results is not guaranteed or predictable, even where the portfolio is structured around a combination of sound financial principles. Not until the strategy is sufficiently defined and modeled can the investor have confidence of its success.

### BRIEF DESCRIPTION OF THE DRAWINGS

FIG. 1 is a block diagram depiction of a computer system configured to implement various ones of the herein described embodiments of the invention.

FIG. 2 is a block diagram of a network architecture that may advantageously be used with the computer system depicted in FIG. 1 for implementing various ones of the herein described embodiments of the invention.

FIG. 3 is a graphic depiction of an investment portfolio in accordance with one or more of the herein described embodiments.

FIG. 4 is a flow chart illustrating a method of selecting investment portfolio components in accordance with one or more of the herein described embodiments.

### DETAILED DESCRIPTION

Much of the inventive functionality and many of the inventive principles described below are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

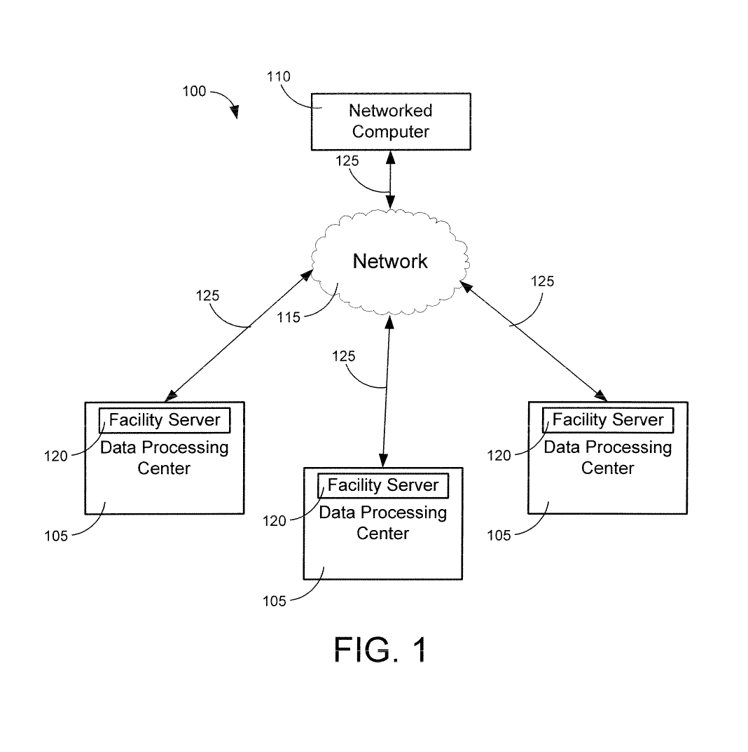

FIG. 1 illustrates an embodiment of a data network 100 including a first group of data processing centers 105 operatively coupled to a networked computer 110 via a network 115. The plurality of provider data processing centers 105 may be located, by way of example rather than limitation, in separate geographic locations from each other, for example, in different areas of the same city or in different states. The network 115 may be provided using a wide variety of techniques well known to those skilled in the art for the transfer of electronic data. For example, the network 115 may comprise dedicated access lines, telephone lines, satellite links, combinations of these, etc. Additionally, the network 115 may include a plurality of network computers 110 or server computers (not shown), each of which may be operatively interconnected in a known manner. Where the network 115 comprises the Internet, data communication may take place over the network 115 via an Internet communication protocol

The networked computer 110 may be a server computer or a workstation computer of the type commonly employed in networking solutions. The networked computer 110 may be used to accumulate, analyze, and download data 125, such as data indicative of the financial or other performance of an investment component. For example, the networked computer 110 may periodically receive data from each of the data processing centers 105 indicative of information pertaining to a stock or other investment component, such as bonds, commodities, exchange traded funds, warrants, real estate investment trusts (REITs) and the like. The networked computer 110 may also be a personal computer at which an investor, portfolio manager or other user may access and view information served from other networked computers 110 or servers 120 coupled to the network 115 or associated with the data processing centers 105. The data processing centers 105 may include one or more facility servers 120 that may be utilized to store information for a plurality of investment components.

Although the data network 100 is shown to include one networked computer 110 and three data processing centers 105, it should be understood that different numbers of computers and processing centers may be utilized. For example, the data network 100 may include a plurality of network computers 110 and dozens of processing 105, all of which may be interconnected via the network 115, sub-networks or otherwise. According to the disclosed examples, this configuration may provide several advantages, such as, for example, enabling near real time uploads and downloads of information as well as periodic uploads and downloads of information. This communication may allow a primary backup of all the information generated in the process of updating and accumulating processing center and investment component data 125.

The networked computer 110 may be connected to the network 115, including local area networks (LANs), wide area networks (WANs), portions of the Internet such as a private Internet, a secure Internet, a value-added network, or a virtual private network. Suitable network computers 110 may also include personal computers, laptops, workstations, mainframes, information appliances, personal digital assistants, and other handheld and/or embedded processing systems. The signal lines that support communications links to a networked computer 110 may include twisted pair, coaxial, or optical fiber cables, telephone lines, satellites, microwave relays, modulated AC power lines, and other data transmission “wires” known to those of skill in the art. Further, signals may be transferred wirelessly through a wireless network or wireless LAN (WLAN) using any suitable wireless transmission protocol, such as the IEEE series of 802.11 standards. Although particular individual and network computer systems and components are shown, those of skill in the art will appreciate that the present invention also works with a variety of other networks and computers.

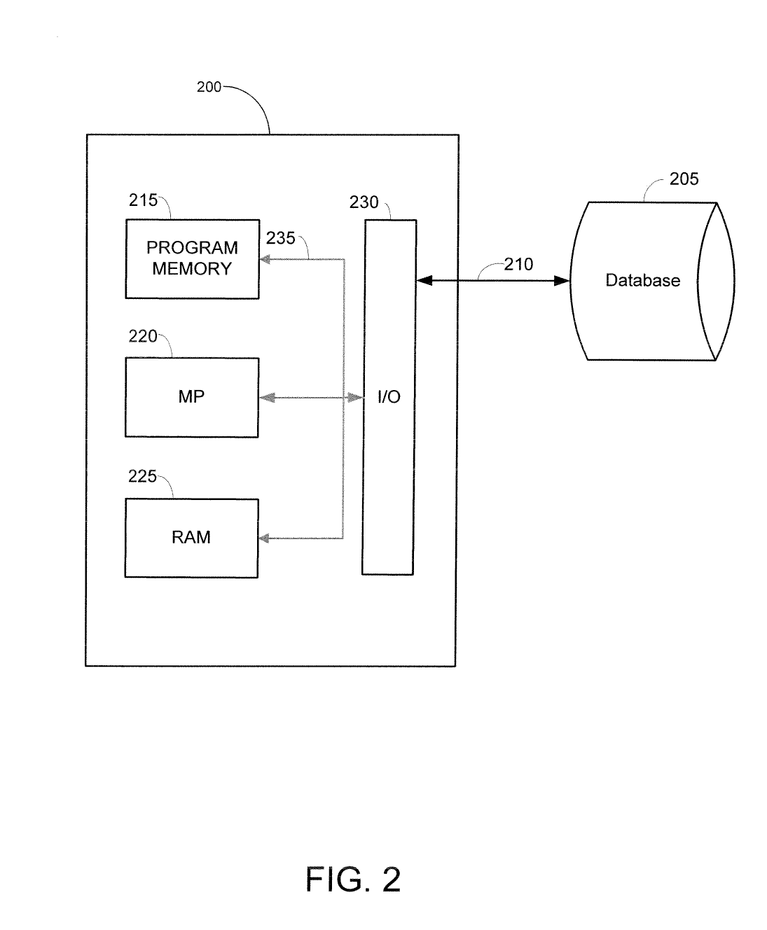

FIG. 2 is a schematic diagram of one possible embodiment of a processing center 105 and/or the networked computer 110 shown in FIG. 1. Each may have a controller 200 that is operatively connected to a database 205 via a link 210. It should be noted that, while not shown, additional databases may be linked to the controller 200 in virtually any known manner.

The controller 200 may include a program memory 215, a microcontroller or a microprocessor (MP) 220, a random-access memory (RAM) 225, and an input/output (I/O) circuit 230, all of which may be interconnected via an address/data bus 235. Appreciated is that although only one microprocessor 220 is shown, the controller 200 may include multiple microprocessors 220. Similarly, the memory of the controller 200 may include multiple RAMs 225 and multiple program memories 215. Although the I/O circuit 230 is shown as a single block, it should be appreciated that the I/O circuit 230 may include a number of different types of I/O circuits. The RAM(s) 225 and program memories 215 may be implemented as semiconductor memories, magnetically readable memories, and/or optically readable memories, for example.

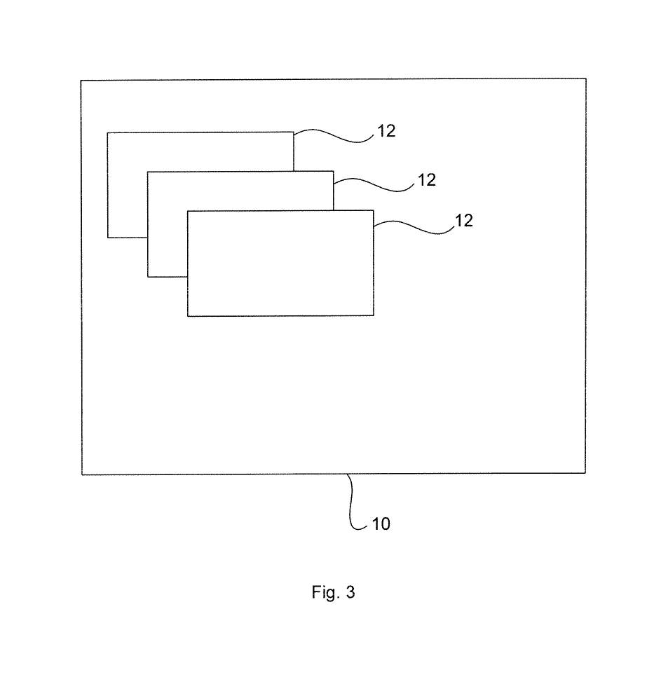

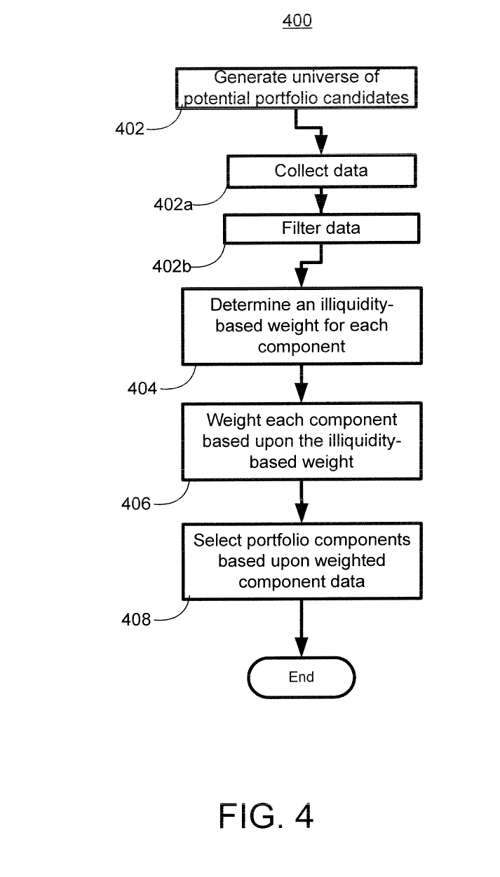

The data network may be configured to create, store, manage, manipulate or otherwise create, act upon or affect an investment portfolio. An investment portfolio 10 (FIG. 3) in accordance with one or more of the herein described embodiments and/or combinations of various aspects of those embodiments includes investment components 12 selected based upon a number of characteristics. For example, the investment components 12 forming the portfolio 10 may be selected based upon one or more characteristics in combination with an illiquidity characteristic. A method 400 (FIG. 4) of selecting investment components of an investment portfolio may include selecting investment components based upon a number of characteristics including one or more characteristics in combination with an illiquidity characteristic. As such, embodiments of the herein described investment portfolio and portfolios defined by the herein described embodiments of methods of selecting investment components of an investment portfolio yield investment portfolios favoring less liquid financial instruments at the expense of under-investing in more liquid financial instruments.

The herein described embodiments of investment portfolios and methods of selecting investment portfolio components, contrary to the risks suggested by the literature in doing so, overweight less liquid investment, and underweight more liquid ones, relative to some liquidity-neutral benchmark portfolio weights for some or all of the components of the portfolio. In one preferred embodiment, a stock's earnings weight is used as a reference benchmark, where the earnings weight is equal to the stock's trailing four-quarters earnings divided by the sum of earnings across all stocks in the relevant universe. A stock's earnings weight is the stock's weight in the universe that is trading volume-neutral and hence market sentiment-neutral. Then, the difference between the stock's earnings weight and its trading volume weight may be referred to as the earnings-based illiquidity bias or simply the illiquidity bias. The volume weight may be determined by any number of methods, and for example, the volume weight may be determined as the stock's total dollar trading volume in the recent 12 months divided by the sum of dollar trading volume over the same period across all stocks in the universe. A stock with a positive illiquidity bias has less trading volume share than warranted by its earnings share, and such is a stock whose turnover rate is lower than the market's average turnover rate. Conversely, a stock with a negative illiquidity bias is traded more frequently than the market as a whole, and thus it is traded “too much” relative to the average turnover of the stock universe.

In an earnings-based illiquidity strategy in accordance with one or more of the herein described embodiments or combinations of various aspects of the herein described embodiments, a stock's portfolio weight may be determined by its earnings weight plus the illiquidity bias. As a result, the portfolio weight for a stock with a positive illiquidity bias is higher than its earnings weight, whereas that for a negative illiquidity-bias stock is less than its earnings weight. For the top 3500 stock universe based on market capitalization for the period from 1972 to 2006, a backtest result demonstrates that such an illiquidity portfolio strategy outperforms the earnings weighted, market-capitalization weighted, and volume weighted portfolio strategies as well as standard benchmark indices, even on a risk-adjusted basis. Thus an illiquidity strategy in accordance with the herein described inventive concepts offers similar capacity as market-capitalization weighted and earnings weighted strategies, and yet it adds value over such traditional investment styles. Unexpectedly, research also shows that the illiquidity investment style goes beyond, and is different from, the size, the value/growth, and the momentum investment styles. The illiquidity strategy unexpectedly represents a particular profitable, large-capacity way to implement an investment portfolio and/or a method of selecting investment components for an investment portfolio based upon an illiquidity style.

Definitions

The following definitions assist understanding of the herein described exemplary embodiments of investment portfolios and methods of generating an investment portfolio. Moreover, comparisons are made of the inventive, illiquidity-biased portfolio strategies in comparison with other known styles. By “illiquidity-biased”, it is meant, without limiting the generality of the concept as demonstrated by the following described examples, an investment portfolio including components or a method of selecting investment portfolio components where, generally more weight is assigned to less liquid components, e.g., stocks, and less weight to components, e.g., stocks, that are turned over frequently.

Suppose there are N stocks in our universe under consideration. For stock n and time t, let En,t be its total earnings in the recent 4 quarters, Cn,t its current market capitalization, and Vn,t the total dollar trading volume in the recent 12 months. Define:
Eₜ [symbol] max {E_{1,t}, 0}+max{E_{2,t}, 0}+ . . . +max {E_{N,t}, 0};
CₜC_{1,t}+C_{2,t}+ . . . +C_{N,t};
VₜV_{1,t}+V_{2,t}+ . . . +V_{N,t},
where max{x,y} means the larger of x and y. Et is thus the sum of positive earnings by all the companies in the universe, where companies with negative earnings are excluded from the calculation at time t, Ct the total market capitalization of all companies, and Et the total dollar volume traded in the recent 12 months by all the stocks in the universe.
Market-Cap Strategy

A common “index” strategy or “market portfolio” strategy is to assign the same weight to a stock as the stock's market capitalization divided by the total market capitalization of all stocks in the universe, that is, Cn,t/Ct is the portfolio weight for stock n. This passive strategy may be referred to as the “market-cap strategy”. It is at the heart of many standard index funds and other mutual fund firms.

Earnings Weighted Strategy or Fundamental Index Strategy

Recently, Arnott, Hsu and Moore (2005) introduced a “fundamental index” strategy in which a fundamental variable such as earnings is considered in the portfolio structure. For example, sales/revenue, book value, and dividends may be used as the basis to determine how much capital is to be invested in a given stock. An “earnings weighted strategy” may be defined by an investment process in which the portfolio weight for any stock n is equal to En,t/Et. Similarly, a “sales weighted strategy”, “book value weighted strategy” and a “dividend weighted strategy” can be defined. The key in a fundamental index strategy lies in its value emphasis. As Arnott stated, traditional market-cap weighted indices have the unintended bias of buying more of past winners and less of past losers, or “buy high and sell low”, which is contrary to value investing. On the other hand, when earnings are used to determine a stock's weight in a portfolio, it is a pure value strategy as the market valuation of the stock does not play any role in determining the portfolio weight.

In the following examples, earnings are considered, instead of sales, dividend or book value. While these other measures may be used in strategies in accordance with the herein described embodiments, care should be taken to fully understand the data. For example, sales or revenue may have quite different meanings across industries. An asset management company may not have much sales compared to a retail company or a computer assembly business, but can be more profitable than the latter. Similarly, a financial service firm may not have much book value as a traditional brick-and-mortar manufacturing business, so book value may not be comparable across industries either. Lastly, a dividend weighted strategy has even more limitations since increasingly more companies today choose not to pay dividends or much dividends (Fama and French (2001)), which unnecessarily disqualifies too many stocks. Though in the following examples an investment component may be excluded from the earnings weighted strategy at the time of portfolio formation if it has negative or no earnings over a recent period, e.g., the most recent 4 quarters, there may be many more companies with positive earnings than with dividends. Furthermore, earnings are comparable across firms and industries.

Volume Weighted Strategy

A portfolio strategy is referred to as a volume weighted strategy if the portfolio weight for a stock n is equal to Vn,t/Vt. Hence, the higher a stock's trading volume, the more capital will be allocated to the stock. This approach favors popular glamor stocks that are highly traded and is biased against stocks that don't attract investor attention. It is therefore a “liquidity strategy” or glamour-biased strategy, and serves to fit investors who like to chase popular “hot” stocks. A volume weighted strategy differs from a traditional momentum strategy.

### EXAMPLE I

### Earnings-Based Illiquidity Strategy

An earnings-based illiquidity strategy in accordance with one possible embodiment of the invention, assigns weights, Wn,t, to each investment component, n, e.g., stock according to:
Wn,t={max (en,t,0)}/Et+({max(En,t,0)}/et−Vn,t/Vt), (1)
where {max(En,t,0)} is the larger of zero or the actual earnings of stock t, Et is the sun of positive earnings of all companies in the universe and {max(En,t,0)}/Et is the earnings weight based on the two components, Vn,t/Vt the volume weight, and ({max(En,t,0)}/Et−Vn,t/Vt),the illiquidity bias, and where we set Wn,t to zero for any stock n for which the above formula results a negative weight.

### EXAMPLE II

### Earnings-Based Illiquidity Strategy with Shorting

Another version of an earnings-based illiquidity strategy in accordance with an embodiment of the invention, assigns weights, Wn,t, to each investment component, n, e.g., stock according to:
Wn,t={max(En,t,0)}/Et+({max(En,t,0)}/et−Vn,t/Vt), (2)
where {max(En,t,0)} is the larger of zero or the actual earnings of stock t, Et is the sun of positive earnings of all companies in the universe and {max(En,t,0)}/Et is the earnings weight based on the two components, Vn,t/Vt the volume weight, and ({max(En,t,0)}/Et−Vn,t/Vt), the illiquidity bias. In this version, negative values are retained such that short-selling considerations are incorporated.

In these two examples, it can be seen that Vt/Et measures the market's volume-to-earnings ratio, or simply the V/E ratio. This V/E ratio indicates how much stock trading there is for each dollar of earnings over a year. For any stock n whose V/E ratio, Vn,t/En,t, is the same as the market's Vt/Et, the methodology provides a portfolio weight, Wn,t=En,t/Et, in which case the stock is given its earnings weight.

On the other hand, if any stock n is traded “too much”, then its illiquidity portfolio weight will be lower than its earnings weight. For example, suppose the earnings weight, En,t/Et=3%, while its volume weight, Vn,t/Vt=5%, then the illiquidity bias, En,t/Et−Vn,t/Vt=−2%. As a result, its illiquidity portfolio weight, Wn,t=3%−2%=1%. Conversely, if a stock is traded less than the market's average, say, En,t/Et=5% and Vn,t/Vt=3%, then En,t/Et−Vn,t/Vt=2% and consequently Wn,t=3%+2%=5%. This stock will be given more than its earnings weight of 3%. The inventive illiquidity strategy rewards less traded stocks with more weight and penalizes over-traded stocks.

Moreover, the inventive illiquidity strategy has the advantage of potentially lower trading impact costs and large capacity as it does not necessarily favor small-cap stocks. A feature of this example is that it starts with the earnings weight as the basis and adds an illiquidity bias. Therefore, large-cap companies will likely take up a portion, perhaps even a majority portion, of the portfolio's capital, yet the strategy has a strong bias favoring less traded stocks and thus derives illiquidity benefits.

The weight definition set forth in equations (1) and (2) can similarly use a dividend weight, cashflow weight, sales weight, or book value weight as the reference to define a dividend-, cashflow-, sales-, or book value-based illiquidity strategy. As a result, measures like volume-to-dividend ratio, volume-to-cashflow ratio, volume-to-sales ratio, and volume-to-book ratio may be introduced to respectively measure the extent to which a component is traded too much or too little for the amount of “fundamentals” the firm produces.

### Example III

### Market Cap-Based Illiquidity Strategy

In a third example of an investment portfolio and/or method of selecting components for an investment portfolio according to the invention, a market-cap weight may be used as the basis to define an illiquidity bias. In such an example, for any stock n:
Wn,t=Cn,t/Ct +[Cn,t/Ct−Vn,t/Vt], (3)
where [Cn,t/Ct−Vn,t/Vt] is the illiquidity bias added to the component n's weight. If the volume weight, Vn,t/Vt, is more than the stock's market-cap weight, Cn,t/Ct, then the stock's portfolio weight will be less than its market-cap weight. In other words, if the stock's volume-to-market cap ratio, Vn,t/Cn,t, is higher than the market's overall volume-to-market cap ratio, Vt/Ct, the stock will be assigned a lower portfolio weight than its market-cap weight. The volume-to-market cap ratio, Vn,t/Cn,t, is equal to the turnover rate when the latter is measured in dollar terms. In general, the volume-to-market cap ratio is more influenced by market valuation than the share volume-based turnover rate.

A potential shortcoming with the market cap-based illiquidity bias of the second example is that the market capitalization of a company incorporates a liquidity premium. Put differently, if a stock is traded liquidly with much trading volume and high turnover, the stock may already be priced higher because of the high liquidity, resulting in a higher market-cap weight, Cn,t/Ct. Thus, the market-cap weight has incorporated at least some of the high volume information, offsetting the information in Vn,t/Vt and neutralizing the illiquidity bias as defined by [Cn,t/Ct−Vn,t/Vt]. In contrast, a fundamental-based illiquidity bias, such as the earnings-based illiquidity bias in the first example, is not subject to this potential shortcoming as the earnings weight is not affected by market valuation information. Nonetheless, because it is demonstrated that the illiquidity bias adds value to a solely market cap-based strategy, a market cap-based illiquidity strategy has benefit.

To implement an illiquidity strategy in accordance with one or more of the herein described embodiments of the invention, the data network 100 may be utilized to collect and process data to generate a universe of potential investment components (402, FIG. 4). For example, data processing centers 105 may comprise one or more of the CRSP and Compustat databases, consisting of firms listed on the New York Stock Exchange (NYSE), American Stock Exchange (AMEX), and NASDAQ stock markets. Upon formation of an investment portfolio (e.g., the end of June and/or December for each year), the data may be collected (402a) at the network computer 115 and the method may apply one or more data filters (402b). For example, components may be limited to the top 3500 stocks based on market capitalization (which is the stock price times the number of shares outstanding). Other potential filters may evaluate share price, and in particular, per-share price may be required to be above a per-share price threshold value, e.g., must be at least $2, the market capitalization may be required to be above a market capitalization threshold value, e.g., the component must have no less than 0.0005% of total market capitalization, and trading volume may be required to be above a trading volume threshold value, e.g. the component must have trading volume no less than 0.0001% of total trading volume. Furthermore, real estate investment trusts (REITs), warrants, exchange traded funds (ETFs), Americus Trust Components, and closed-end funds may be excluded. Lastly, a component must have available information on dollar trading volume and monthly returns, earnings, number of shares outstanding, and stock price, for the recent 12 months.

Once the universe is established, for each member of the universe an illiquidity-based weight is determined (404). Using the illiquidity weight, each of the members of the universe is weighted (406) allowing selection of the portfolio components (408) at least based upon the illiquidity weight. Of course, the investment portfolio 10 may incorporate components based upon criteria other than illiquidity, however, the portfolio 10 will include at least one or more components in consideration of illiquidity.

In the above examples, all stock returns are total returns with dividends included, which may be collected from CRSP. Earnings for each company are the earnings per share (EPS) times the number of shares outstanding at the portfolio formation date. In particular, the four most recent quarterly EPS may be considered, with the most recent quarter ending two months prior to the portfolio formation date. This is to avoid any forward-looking biases as it usually takes several weeks for a company to report its recent quarterly earnings after the end of the quarter. The earnings data may be obtained from any suitable source, such as Compustat. Additionally, and price or volume adjustments may be applied, e.g., NASDAQ stocks may have their trading volume adjusted accordingly because of the well known duplicated reporting practice employed by NASDAQ market makers. Additionally, after application of the filters, the universe of available investment components should be considered to determine there remains a sufficient number of components to provide meaningful comparison.

An investment portfolio in accordance with one or more of the herein described inventive embodiments includes at least some portion of its investment components based upon a positive illiquidity bias applied to the investment component. Virtually any measure of liquidity may be used, and several examples include: bid-ask spread, market depth, trading volume, price impact per dollar traded. Generally, liquidity may refer to the speed at which a large quantity of a security can be traded with a minimal impact on the price and at the lowest cost. All three common measures of liquidity—trading volume, bid-ask spread, and price impact—are correlated with each other, and yet they are different. It is hard to come up with one function that captures all three, and each is also highly correlated with company size.

In one preferred embodiment, dollar trading volume may be used as a direct measure of liquidity. Additionally or alternatively, annual turnover, defined as the number of shares traded divided by the stock's outstanding shares, may be employed as a proxy of the stock's liquidity. Trading volume favors large-size stocks, which is perhaps what any liquidity measure should do as large stocks are generally more tradable. Turnover is relatively market capitalization-neutral as small-cap and large-cap stocks can have both low and high turnover rates. High turnover stocks tend to have low bid-ask spread, high trading volume relative to the size of the company, and low price impact per dollar traded.

Liquidity does not necessarily mean size, and hence size-based strategies are not the same as the herein described illiquidity based strategies. In addition to the academic literature on size as a profitable investment style (Fama and French 1993), there are many small-cap and mid-cap mutual funds and managed accounts, indicating that size is a popular differentiating factor in investment practice. In both academic and practitioner discussions on liquidity, it is often taken as a given that illiquidity equals small cap, so betting on illiquidity must mean betting on small-cap stocks. The applicants have not found this to be the case. To see whether illiquidity is captured by size, analysis of periodic independently sorted size and turnover quartiles reveals several things. Across the small-cap quartile, the low-turnover group cams a geometric average return of 17.80% a year while the high-turnover group 4.32% a year, resulting in an illiquidity effect of 13.48% a year. Across the large-cap quartile, the low- and high-turnover groups respectively earn 13.21% and 9.74%, producing an illiquidity effect of 3.47%. Within the two mid-size groups, the illiquidity return spread was also observed to be significant. Therefore, size does not capture illiquidity and the illiquidity effect holds regardless of the size group. However, it is true that an illiquidity effect is the strongest among small-cap stocks and then declines from small- to mid- and to large-cap stocks.

The herein described embodiments of an illiquidity-based strategy are also different than a value-based strategy. Analysis of periodic sorted earnings/price (E/P) ratio data quartiles, as a proxy for value, reveals among the low-value (or, high-growth) stocks, the low-turnover stock portfolio has a compounded annual return of 10.77% while the high-turnover stock portfolio 2.73%, resulting in an illiquidity effect of 8.05% a year. A similar illiquidity effect is achieved among high-value stocks: an annual return differential of 7.9% between low- and high-turnover stocks. That is, the illiquidity effect is stronger as we move from low- to high-value stocks. Therefore, value and illiquidity are distinct stock-picking styles. And, in accordance with the herein described embodiments, preferred portfolios, and perhaps the best, combine high-value with low-turnover stocks in view of illiquidity.

Momentum also is not illiquidity. Analysis of the literature reveals that buying past medium-term winners and selling past medium-term losers and holding the positions for a medium term (6 to 18 months) yields significant profits. These studies have confirmed a common practice among certain groups of investors who follow trends using charts or simple return calculations. After the research results from the literature came out, momentum investing has received more following on a larger scale among institutional money managers. Two dimensional portfolios based on independent sorting of the stock universe according to past 12-month stock returns (momentum) may be formed and sorted into quartiles as described above. The applicants find that the highest compound annual return, 19.38%, is achieved by buying high-momentum low-turnover stocks, while the lowest return, 5.46%, is for the low-momentum high-turnover stocks. The illiquidity effect (the difference between low- and high-turnover stocks) is 5.99% for the low-momentum quartile, 7.20% for the low-middle momentum, 5.19% for the high-middle momentum, and 8.91% for the high-momentum stock quartile Again momentum and illiquidity are different stock-picking styles and not substitutes for one another. In accordance with the herein described embodiments, a better way may be to combine the two investment styles and pick stocks that have high momentum but low turnover, i.e., high illiquidity.

The herein described preferred embodiments may be characterized as “passive” investment strategies, in the sense that they are designed to take advantage of certain easily observable stock attributes and these attributes are converted into a stock's portfolio weight in a way that is “passive” and simple. That is, the preferred embodiments of earnings-based illiquidity and market cap-based illiquidity strategies, or illiquidity-based strategies incorporating some portion or all of various other weighting data, may all be considered “passive” investment approaches, as each of them relies on no more than the weighting of publicly available market cap, volume, earnings, etc. information in addition to illiquidity. The ways in which these variables are weighted or used to form the various portfolio weighting strategies can be influenced by other findings and data, and to the extent they are, the strategy introduces non-passiveness. Nonetheless, they can generally be viewed as “style index” strategies.

Examining the performance of these different portfolio weighting strategies, test data for various periods may be observed and compared. For example, defining a test period from January 1972 to December 2006 and the universe to include up to the top 3500 stocks based on market cap and after applying filtering rules such as minimum market-cap, minimum trading volume, and minimum per-share price, e.g., $10 million, $26 million in trading volume and $2/share, respectively. The following table displays past performance results when the five strategies described above are applied to the end of each June and December from 1972 to 2006.

| | Compound | Average | |
|---|---|---|---|
| | Annual | Annual | Standard |
| Strategies | Return | Return | Deviation |
| Earnings-Based Illiquidity | 16.02% | 17.10% | 13.76% |
| Volume Weighted | 8.93% | 10.78% | 18.67% |
| Market Cap Weighted | 10.55% | 11.93% | 15.42% |
| Earnings Weighted | 12.72% | 13.90% | 14.78% |
| Market Cap-Based Illiquidity | 11.19% | 12.45% | 14.09% |

The geometric annual return is the highest, 16.02%, for the earnings-based illiquidity strategy followed by 12.72% for the earnings weighted strategy, 11.19% for the market cap-based illiquidity strategy, 10.55% for the market-cap weighted strategy, and 8.93% for the volume weighted strategy. Thus, the excess return is 3.30% by the earnings-based illiquidity over the earnings weighted strategy and adding the earnings-based illiquidity bias helps improve the performance of value investing. The market cap-based illiquidity strategy adds 0.64% excess return to the market-cap weighted Strategy. In this case, the return added by investing in illiquidity (defined relative to the market-cap weight) is 0.64%

The volume weighted strategy has the worst return, implying that buying more of heavily traded stocks lowers investment returns. Popular glamour stocks that are traded a lot hurt performance. For comparison, over the same period, the compound annual return is 11.45% for the S&P 500.

Volatility or return standard deviation is all between 13.76% and 15.42% across the strategies, except that the volume weighted strategy's volatility is 18.67%. Therefore, biasing investments to favor liquid and high-volume stocks not only gives the lowest return but also leads to the highest volatility. This can be seen by the information ratio (defined as the ratio between average annual return and volatility), which is 1.16 (the highest) for the earnings-based illiquidity strategy, 0.68 for the market-cap weighted strategy, and 0.48 (the lowest) for the volume weighted strategy. For the S&P 500, the information ratio is 0.76.

The foregoing discussion and comparison of illiquidity-based strategies with traditional strategies demonstrates the superior performance of an illiquidity-based strategy. The questions are why haven't illiquidity-based strategies been tried and will the superior performance continue into the future. That is, if one applies this portfolio technology to managing investments in the future, will it outperform others strategies?

By investing in illiquidity, the strategy serves as a liquidity provider and hence is compensated. Considering the mobilization and liquification of capital, i.e., the making of otherwise illiquid or hard-to-move assets more liquid, provides for more efficient allocation of capital, which creates economic value. In a classic sense, investors are generally willing to pay more for liquid investment vehicles. The liquidity premium makes liquid securities priced higher than otherwise, which means that liquid securities have lower expected future returns. By the same logic, illiquid or less liquid securities are valued lower, resulting in a higher expected return for these securities. Therefore, when the preferred embodiments of illiquidity-based investment strategies invest more heavily in less liquid value components, the strategy is rewarded with higher future returns because it provides liquidity to the market by being more willing to take larger positions in illiquid stocks.

Trading volume is often viewed by traders and investors as an indicator of investor interest or the degree of the stock's popularity. If there is too much interest in the stock and the stock becomes glamorous, the trading volume will be high and turnover will be extraordinary too, pushing the stock price higher than justified by fundamentals. Conversely, a low volume-to-earnings ratio implies an unjustified low interest in the stock, likely causing the stock price to be too low. Therefore, by avoiding or investing less in stocks that are popular and traded heavily and putting more capital in low volume-to-earnings stocks, the illiquidity-based strategy reduces its exposure to speculative fever risk and puts more weight on “diamonds in the rough”.

As a result of the financial revolution in America and beyond, more and more assets and future cashflows are being converted into financial capital that can be used or put into new investments. The degree of financialization is unprecedented. As the supply of financial capital increases in markets, the liquidity of securities of all kinds has to rise. Therefore, as financial capital supply grows over time, the high tide lifts all boats: all securities will have rising liquidity. Therefore, by investing more heavily in current less liquid stocks, the illiquidity investment style benefits from the rising tide of increasing financialization and higher liquidity over time. Such rising liquidity makes past illiquid stocks valued more now and in the future.

These sources of extra return for illiquid stocks are not expected to disappear Liquidity will continue to be valued high and illiquid stocks will still come at a discount. There will always be glamour stocks and overlooked value stocks. Especially as the American style financial capitalism spread to Western Europe, Eastern Europe, Asia and Latin America, global supply of financial capital will only grow more in the future. For these reasons, the illiquidity investment style indicates continued outperformance.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. An investment portfolio comprising an investment component, the investment component being characterized by an illiquidity bias.

2. The investment portfolio of claim 1 the investment component being one of a plurality of investment components in the investment portfolio.

3. The investment portfolio of claim 2, each of the plurality of investment components being characterized by an illiquidity bias.

4. The investment portfolio of claim 1, the investment component being characterized by one of a market capitalization weight, a dividend weight, a cashflow weight, a sales weight, an earnings weight or a book value weight.

5. The investment portfolio of claim 1, the illiquidity bias comprising an illiquidity weight.

6. The investment portfolio of claim 1, the investment component being characterized by a weight including the illiquidity bias.

7. The investment portfolio of claim 1, the illiquidity bias comprising a positive illiquidity bias.

8. The investment portfolio of claim 1, the investment component being further characterized by a market capitalization bias, an earnings bias or a volume bias.

9. The investment portfolio of claim 1, the investment component being further characterized by a value component.

10. The investment portfolio of claim 1, the value component being characterized by a low volume-to-earnings ratio.

11. A method of selecting investment components of an investment portfolio comprising:
generating a universe of potential investment components;
determining an illiquidity of at least one of the potential investment components; and
selecting the investment component based upon the illiquidity.

12. The method of claim 11, wherein determining an illiquidity comprises determining an illiquidity for each of the potential investment components, the method further comprising weighting each of the potential investment components to generate weighted investment components and wherein selecting the investment component comprises selecting the investment component based upon the weighted investment components.

13. The method of claim 12, the investment component further being selected based upon by one of a market capitalization weight, a dividend weight, a cashflow weight, a sales weight, an earnings weight or a book value weight.

14. The method of claim 11, wherein the illiquidity comprises an illiquidity bias.

15. The method of claim 14, the illiquidity bias comprising a positive illiquidity bias.

16. The method of claim 14, the investment component further being selected based upon a market capitalization bias, an earnings bias or a volume bias.

17. The method of claim 1 1, the investment component further being selected based upon a value component.

18. The method of claim 17, the value component being characterized by a low volume-to-earnings ratio.
